(19) United States
(12) Patent Application Publication
(10) Pub. No.: US 2011/0081515 A1
(43) Pub. Date: Apr. 7, 2011

(54) PROCESS FOR PRODUCING EXTRUDATES, AN EXTRUDED PROFILE AND ITS USE AS WIPING RUBBER

(75) Inventor: Reiner Lay, Aachen (DE)

(73) Assignee: ROBERT BOSCH GMBH, Stuttgart (DE)

(21) Appl. No.: 12/989,144

(22) PCT Filed: Mar. 4, 2009
(86) PCT No.: PCT/EP09/52552

§ 371 Date: Dec. 1, 2010

(30) Foreign Application Priority Data
Apr. 23, 2008 (DE) 10 2008 001 347.1

(51) Int. Cl. B60S 1/38; B32B 3/02; B29C 47/06

(52) U.S. Cl. 428/60; 428/172; 264/171.24

(57) ABSTRACT

The invention relates to a method for producing extrudates comprising a first profiled section (1) made of an elastomer material and a second profiled section (13) that is connected to the first profiled section (1). In said method, the first profiled section (1) made of the elastomer material is first extruded and is then fully cured, whereupon a second profiled section (13) made of a thermoplastic material is extruded onto the first profiled section (1). The invention further relates to an extruded profiled element comprising a first profiled section (1) and a second profiled section (13) that is connected to the first profiled section (1). The first profiled section (1) is made of an elastomer material while the second profiled section (13) contains a thermoplastic material.

### BACKGROUND OF THE INVENTION

The invention relates to a process for producing extrudates comprising a first profile composed of an elastomer material. The invention further relates to an extruded profile comprising a first profile and a second profile joined to the first profile.

Extruded profiles composed of an elastomer material are used, for example, for wiping rubbers. Such wiping rubbers are used, for example, in windscreen wipers of motor vehicles or, for example, also in squeegees, as are used, for example, for cleaning panes of glass.

Extruded profiles used for wiping rubbers generally comprise a base section and a lip section. The material requirements for the base section and the lip section are generally different. When the extruded profile is used for windscreen wipers in motor vehicles, the base section and the lip section are generally joined to one another via a tilting web. The lip section is usually formed on a triangular pivoting part which is joined to the base part via a tilting web. To achieve sufficiently good wiping behavior of the wiping rubber, the lip section is usually formed by a material having low friction on glass and high wear resistance. On the other hand, the tilting web should have, for example, high flexibility and weathering resistance. To achieve the different properties, DE A 35 27 093, for example, discloses making a wiping rubber of a material which comprises predominantly EPDM and is vulcanized by means of a peroxide and has a lip part whose contact parts sliding on the surface are formed by chlorinated diene-type rubber. This is produced, for example, by a coextrusion process in which the rubber in the region of the lip parts is chlorinated after coextrusion.

Furthermore, it is usual to join the base section to a support profile. The support profile is usually likewise made of an elastomer material. The wiping rubber together with support profile is usually produced by a coextrusion process. Depending on requirements for the wiping rubber, the support profile can have a spoiler.

After leaving the extruder, the elastomer composition of which the wiping rubber and the support profile are formed is not yet crosslinked and is therefore soft and plastic. Permanent deformation of the profile can occur as a result of gravity and buoyancy of the profile in a salt bath used for vulcanization. This leads to considerably impaired function of the wiping rubber.

### SUMMARY OF THE INVENTION

Advantages of the invention

A process according to the invention for producing extrudates comprising a first profile composed of an elastomer material and a second profile joined to the first profile, which comprises the following steps:

a) extrusion of the first profile composed of the elastomer material,

b) vulcanization of the first profile composed of the elastomer material and

c) extrusion of a second profile composed of a thermoplastic material onto the first profile composed of the elastomer material.

An advantage of the process of the invention is that due to the separate production of the first profile and the second profile, a profile having a comparatively simple cross section composed of the elastomer material can be produced initially. Owing to the smaller and simpler cross section and thus the lower mass, the influence of gravity on the first profile is lower. A lower degree of deformation occurs. In addition, high extrusion speeds for the first profile are possible because of its simple geometry. To avoid deformation or to reduce deformation, it is also possible to configure the first profile so that it has, for example, support surfaces on which the profile can rest during transport and vulcanization.

A further advantage of the process of the invention is that the thermoplastic material of the second profile has good dimensional stability immediately on leaving the molding tool. In this way, deformation is also avoided after application of the second profile.

In a preferred embodiment, the first profile has at least two support surfaces, in particular four support surfaces. As a result of the four support surfaces, the first profile suffers only minimal deformation. Particularly when the process is used for producing wiping rubber, the four support surfaces result in no or only minimal deformation in the region of the lip head. The first profile is in this case configured as a double profile in which two wiping rubbers are joined to one another in the region of the wiper lip.

To obtain good adhesion of the second profile to the first profile, preference is given to the second profile composed of the thermoplastic material being extruded onto the first profile composed of the elastomer material in step (c) before the first profile has cooled completely. The second profile is preferably extruded onto the first profile immediately after vulcanization has been completed. For this purpose, the first profile is fed into an extruder and passed through the extrusion die in which the thermoplastic material for the second profile is extruded onto the first profile. To achieve better adhesion between the first profile and the second profile, the surface of the first profile can be activated by application of a plasma flame immediately before the second profile is extruded on.

The first profile composed of the elastomer material can be made of one or more components. When the first profile composed of the elastomer material is made of a plurality of components, a coextrusion process is usually used. The use of different materials enables, for example, different properties of the individual regions of the first profile to be set. Thus, for example, when the profile is a profile for a wiping rubber, it is desirable that this has low friction in the region of the wiping lip which is conveyed over a pane. On the other hand, high flexibility and good heat distortion resistance is required in the region of a tilting web by means of which the lip section is joined to a base section.

When the first profile is a wiping rubber, the second profile is usually a support profile joined to the wiping rubber. Such a support profile is generally a hollow profile and, in one embodiment, has at least one hollow space into which a spring rail can be inserted. The use of the thermoplastic material which has greater dimensional stability than an elastomer material of which the support profile is made according to the prior art enables wider spring rails to be realized.

To prevent the wiping rubber lifting off from the pane during travel, the support profile has, in a preferred embodiment, a spoiler lip. The spoiler lip is usually shaped so that the wiping rubber is pressed against the windscreen by the airflow during travel.

In general, the support profile is not subjected to very high thermomechanical stress during use of the wiper. For this reason, the thermoplastic material can replace the expensive elastomer material known from the prior art for the support profile. When the support profile has a spoiler lip, particular preference is given to the spoiler point being made of a soft material. Suitable soft materials for the spoiler point are, for example, soft thermoplastics or thermoplastic elastomers.

The elastomer material of which the first profile is made is preferably selected from the group consisting of natural rubber (NR), chloroprene rubber (CR), butadiene rubber (BR), styrene-butadiene rubber (SBR), ethylene-propylene copolymer (EPM), ethylene-propylene-diene terpolymer (EPDM), ethylene-vinyl acetate copolymers (EVM), acrylonitrile-butadiene rubber (NBR), hydrogenated acrylonitrile-butadiene rubber (HNBR), polyurethane elastomers (PUR) and mixtures of these materials.

The elastomer material is particularly preferably selected from among ethylene-propylene-diene terpolymer, natural rubber, chloroprene rubber and mixtures thereof.

According to the invention, the thermoplastic material is a thermoplastic or a thermoplastic elastomer. As thermoplastic for the second profile, it is possible to use any desired thermoplastic known to those skilled in the art. Suitable thermoplastics are, for example, polyolefins, for example polypropylene or polyethylene, polyamides, e.g. poly-amide 6, polyamide 6.6 or polyamide 4.6, polyvinyl compounds, for example polyvinyl chloride, polyvinylidene chloride, polyvinyl esters, polyvinyl alcohols, polyvinyl acetals, polyvinyl ethers, styrene polymers, for example polystyrene, styrene-acrylonitrile copolymers, acrylonitrile-butadiene-styrene copolymers, polyacrylic acid, poly(meth)acrylic esters, polyacrylates, polymethyl methacrylate, poly-acryl-amide, polycarbonate, polyoxymethylene, polyphenylene ethers, fluorinated polymers, polyaromatics, for example poly-phenylene sulfide, polyether sulfones, polyether ketones, polyimides, polyquinoxalines, polyquinolines, poly-benz-imidazoles, polyesters, polyurethanes, for example poly-iso-cyanates, polyols such as polyether polyols or polyester polyols.

Preferred thermoplastics are polyolefins, in particular polyethylene or polypropylene, polyamides and polyacrylates.

Suitable thermoplastic elastomers are, for example, thermoplastic vulcanizates (TPV), e.g. ethylene-propylene-diene terpolymer/polypropylene blends (EPDM/PP), thermoplastic polyolefins, e.g. styrene-ethylene-butylene-styrene copolymer (SEBS), or thermoplastic polyurethanes.

A further advantage of the use of a thermoplastic material for the second profile is that this no longer has to be vulcanized after extrusion. For this reason, no further thermal damage to the first profile occurs.

To obtain the spring force necessary for a wiping blade of a windscreen wiper, it is necessary to use a spring rail, usually a metallic spring rail, when using a thermoplastic which is not resistant to high temperatures or a thermoplastic elastomer. To be able to dispense with the use of a spring rail, the thermoplastic material of which the second profile is made is therefore, in a particularly preferred embodiment, a high-temperature-resistant thermoplastic. Suitable thermoplastics are, for example, aromatic polyamides, liquid crystal polymers (LCP) or polyphenylene sulfide (PPS).

The thermoplastic used can be filled or unfilled. When a filled thermoplastic is used, it is, for example, filled with glass fibers, carbon fibers or aramid fibers. It is possible to use both short fibers and long fibers. Preference is given to using glass fibers, very particularly preferably long glass fibers. For the purposes of the present invention, long glass fibers are fibers having a fiber length in the range from 5 to 20.

An advantage of the use of a high-temperature-resistant thermoplastic is that the metallic spring rail can be dispensed with completely. This is, in particular, possible because the high-temperature-resistant thermoplastic does not soften when subjected to sunlight. The omission of the metallic spring rail enables the weight of the windscreen wiper to be reduced. The number of parts used is also reduced. In addition, no corrosion on metallic components occurs. In this way, the life of the wiper blade can be increased.

To achieve the spring force necessary for operation of a windscreen wiper, the extruded profile is preferably bent into a desired shape before cooling of the thermoplastic. After bending, the extruded profile is cooled and subsequently cut to the required length.

The invention further provides an extruded profile comprising a first profile and a second profile joined to the first profile, where the first profile is made of an elastomer material. The second profile contains a thermoplastic material.

Suitable elastomer materials for the first profile are all the elastomer materials described above. The thermoplastic material for the second profile is a thermoplastic or a thermoplastic elastomer. Suitable thermoplastics or thermoplastic elastomers have likewise been described above.

In a preferred embodiment, the first profile is a wiping rubber and the second profile is a support profile joined to the wiping rubber. Such a support profile preferably has at least one hollow space. The hollow space in the support profile enables uniform wall thicknesses to be achieved. The second profile can cool uniformly as a result. Temperature stresses which occur can be reduced in this way. When a spring rail is to be inserted into the support profile, it is possible, for example, to configure a hollow space in such a way that the spring rail can be inserted into this. However, particularly when using a high-temperature-resistant thermoplastic, the use of a spring rail is not necessary. In addition, the support profile can be provided with a spoiler lip.

In a preferred embodiment, the first undercut via which the first profile is joined to the second profile. As a result of the undercut in the first profile, into which the second profile engages, a mechanically stable connection between the first profile and second profile is achieved. This enables the connection between the first profile and the second profile to be improved compared to a second profile extruded onto the first profile without an undercut.

### BRIEF DESCRIPTION OF THE DRAWINGS

Illustrative embodiments of the invention are shown in the drawings and described in more detail in the description below. In the drawings,

FIG. 1 shows a cross-sectional view of two wiping rubbers joined to one another in the lip section,

FIG. 2 shows a cross-sectional view of two wiping rubbers which are joined to one another in the lip section and are joined to a support profile,

FIG. 3 shows a cross-sectional view of two wiping rubbers which are joined to one another at the lip section and are joined to a support profile having a spoiler lip,

FIG. 4 shows a cross-sectional view of two wiping rubbers which are joined to one another at the lip section and have an undercut,

FIG. 5 shows a cross-sectional view of two wiping rubbers which are joined to one another at the lip section, have an undercut and are joined to a support profile,

FIG. 6 shows a cross-sectional view of two wiping rubbers which are joined to one another at the lip section, have an undercut and are joined to a support profile having a spoiler lip,

FIG. 7 shows a cross-sectional view of two wiping rubbers which are joined to one another at the lip section, have an undercut and are joined to a support profile without a hollow space,

FIG. 8 shows a cross-sectional view of two wiping rubbers which are joined to one another at the lip section, have an undercut and are joined to a support profile without a hollow space for a spring rail and with a spoiler lip.

### DETAILED DESCRIPTION

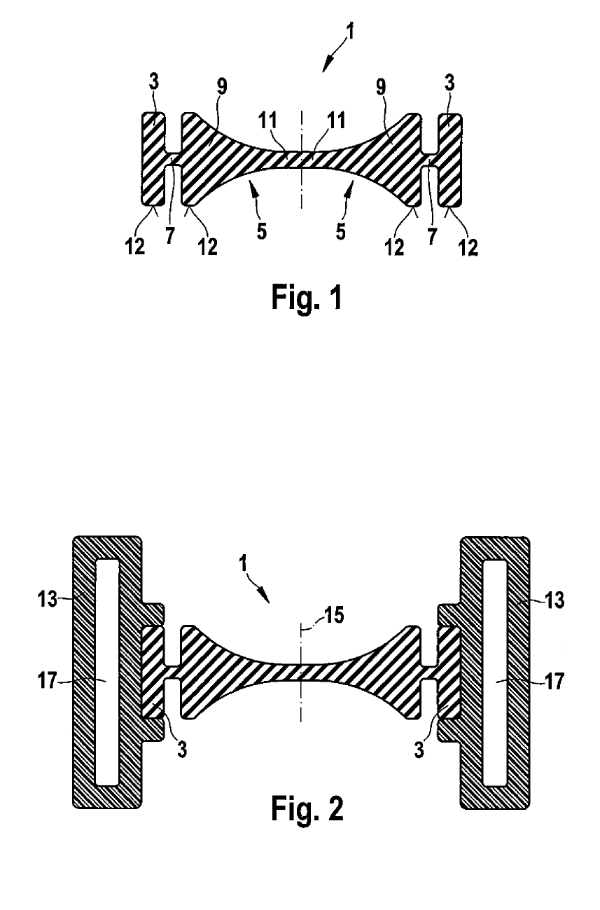

FIG. 1 shows a cross-sectional view of two wiping rubbers joined to one another at the lip section.

A first profile 1 composed of an elastomer material which is used for producing a wiping rubber for windscreen wipers is generally produced as a tandem. Here, two wiping rubbers are joined to one another. They are generally joined in the region of the future wiping lip of the wiping rubber.

A wiping rubber generally comprises a base section 3 and a lip section 5. The base section 3 and the lip section 5 are usually joined to one another via a tilting web 7.

The lip section 5 generally comprises a pivoting part 9 and a lip part 11. The lip part 11 is formed on the front section of the pivoting part 9. When producing the first profile 1, the two wiping rubbers are joined to one another at the lip part 11. To produce individual wiping rubbers, the first profile 1 is usually separated by means of a knife cut in the region of the lip part 11. In the case of the extrudate configured according to the invention, however, the first profile 1 is separated only after application of the second profile, which is not shown in FIG. 1.

A good function of the wiping rubber can be achieved by using different materials by means of which the functions to be performed by the individual sections can best be achieved at different points of the first profile 1. Production of the wiping rubber composed of different materials is achieved, for example, by coextrusion using a plurality of materials. Thus, for example, the base section 3 and the tilting web 7 can be made of an inexpensive and ageing-resistant material, while the lip part 11 or the lip section 5 is produced from a high-quality material which has a low coefficient of friction on glass and high wear resistance. However, it is also possible to produce the entire first profile 1 from only one material.

Suitable materials for the first profile 1 are, for example, ethylene-propylene-diene terpolymer (EPDM), natural rubber (NR), chloroprene rubber (CR) or a mixture thereof.

When the lip section 5 or the lip part 11 is made from a different material, a suitable material is, for example, a mixture of natural rubber and polytetrafluoro-ethylene. It is also possible, for example, to make the base section 3 and the tilting web 7 of EPDM and the lip part 11 of natural rubber.

Preference is given to both the pivoting part 9 and the base section 3 having support surfaces 12. During vulcanization, the extruded profile 1 rests on the support surfaces 12. In this way, deformation of the first profile 1 during vulcanization is prevented or greatly reduced.

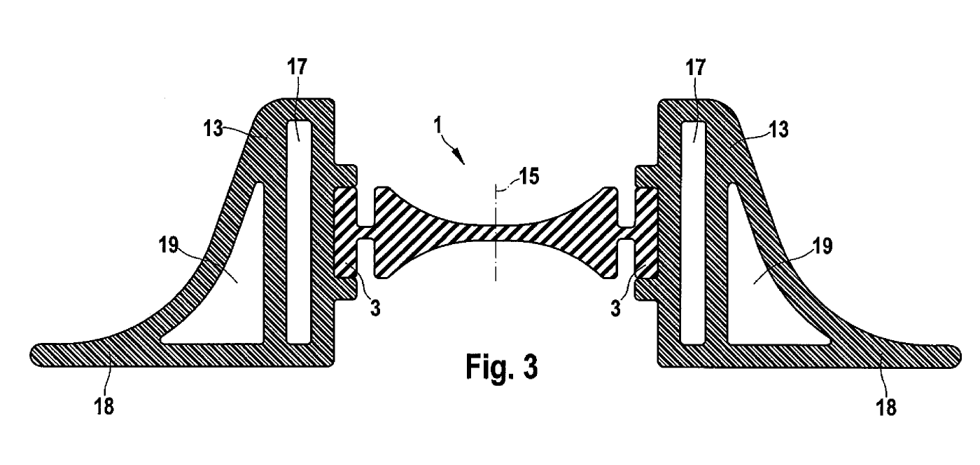

According to the invention, the first profile 1 is joined to a second profile 13. This is shown in FIG. 2. In the case of a symmetrical first profile 1 used for producing wiping rubbers, two second profiles 13 are joined to the first profile 1. The second profiles 13 usually have the same shape, but are formed symmetrically about an axis of symmetry 15. The axis of symmetry 15 is at the same time the cutting line at which the first profile is separated to produce individual wiping rubbers.

In the embodiment shown here for producing a wiping rubber, the second profile 13 is joined to the base section 3 of the first profile 1. For this purpose, the second profile 13 is extruded onto the first profile 1. This is usually effected by conveying the first profile 1 through an extrusion die while the second profile 13 is formed. To avoid deformation of the first profile 1 while the second profile 13 is applied, the first profile 1 is, according to the invention, vulcanized before the second profile 13 is extruded on. The vulcanization hardens the polymer material of the first profile 1 and the first profile 1 becomes dimensionally stable. The vulcanization can be carried out by any methods known to those skilled in the art. The first profile 1 is usually vulcanized in a hot air oven or a salt bath.

The second profile 13 which is extruded onto the first profile 1 after vulcanization of the latter is, according to the invention, made of a thermoplastic material. Both thermoplastics and thermoplastic elastomers are suitable for this purpose. The second profile 13 is usually joined physically to the first profile 1. Here, the thermoplastic material of the second profile 13 adheres to the elastomer material of the first profile 1. Good adhesion is obtained particularly when the second profile 13 is extruded onto the first profile 1 before the latter has cooled after vulcanization.

According to the invention, the thermoplastic material for the second profile 13 is a thermoplastic or a thermoplastic elastomer. Suitable thermoplastics are, in particular, polyolefins, for example polyethylene or polypropylene, or polyamides. Preferred thermoplastic elastomers are thermoplastic vulcanizates such as a mixture of ethylene-propylene-diene terpolymer and polypropylene (EPDM/PP), thermoplastic polyolefins or thermoplastic polyurethanes.

When the extrudate produced by the process of the invention is used as wiping rubber, in particular as wiping rubber for windscreen wipers of motor vehicles, the second profile 13 is generally a support profile. This preferably comprises a hollow space 17. A spring rail for a wiping blade can be inserted in the hollow space 17. The use of the thermoplastic material for the second profile 13 allows the hollow space 17 to be made larger than in the process known from the prior art, in which the second profile 13 is made of the same material as the first profile 1. This is attributable to the better dimensional stability of the thermoplastic material, in particular the dimensional stability immediately on leaving the extruder die.

An alternative embodiment is shown in FIG. 3.

The embodiment shown in FIG. 3 likewise comprises a first profile 1 which is joined to second profiles 13. In contrast to the embodiment shown in FIG. 2, the two profiles 13 in the embodiment shown in FIG. 3 each comprise a spoiler lip 18. During operation of the windscreen wiper for which the wiping rubber is used, the spoiler lip serves to press the wiper blade against the windscreen. The second profile 13 shown in FIG. 3 also comprises a hollow space 17 into which a spring rail (not shown here) can be inserted. To achieve a uniform wall thickness and thus uniform curing and cooling, the spoiler lip 18 encloses a second hollow space 19.

When the second profile 13 is made of a thermoplastic, preference is given to the spoiler lip 18 being made of a soft material. Suitable materials are, for example, a soft thermoplastic, e.g. a soft polyolefin, or a thermoplastic elastomer.

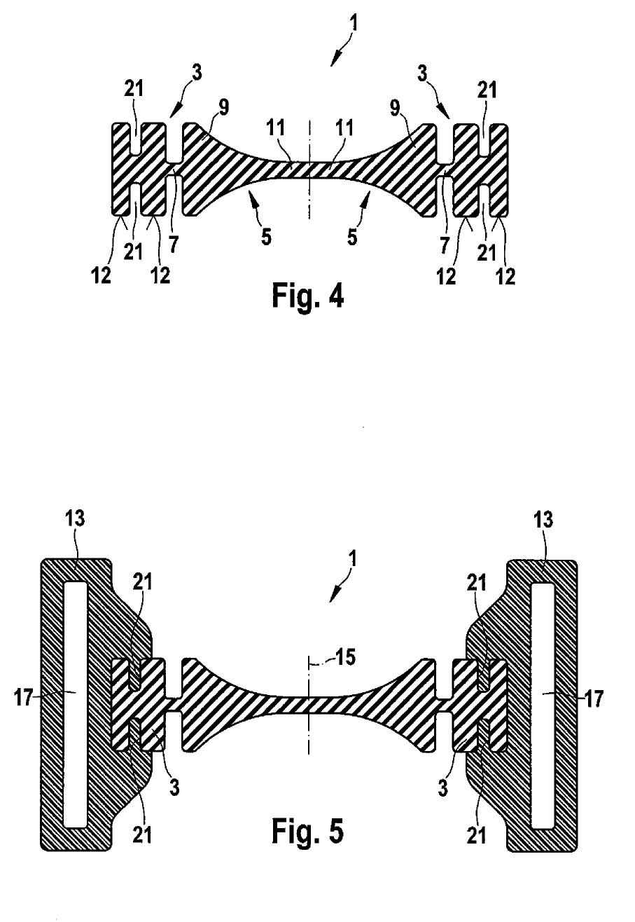

An alternative embodiment of a first profile 1 is shown in FIG. 4. The first profile 1 shown in FIG. 4 differs from the first profile 1 shown in FIG. 1 in that the base section 3 has two grooves 21 opposite one another behind the tilting web 7. The grooves 21 serve as undercut for joining the first profile 1 to the second profile 13. This is shown by way of example in FIG. 5.

In the embodiment shown in FIG. 4, the base section 3 preferably has two support surfaces 12 in each case. Here, one support surface 12 is located in front of the undercut 21 and one support surface 12 is located behind the undercut 21. As in the embodiment shown in FIG. 1, the support surfaces 12 avoid deformation of the extruded profile 1 during vulcanization.

In the embodiment shown in FIG. 5, the second profile 13 is a support profile having a hollow space 17 into which a spring rail can be inserted. On extrusion of the second profile 13 onto the first profile 1, the material penetrates into the grooves 21. In addition to the adhesion of the thermoplastic material of the second profile 13 to the elastomer material of the first profile 1, this leads to an additional stable connection of the profiles 1, 13. Separation of the profiles 1 and 13 is made more difficult.

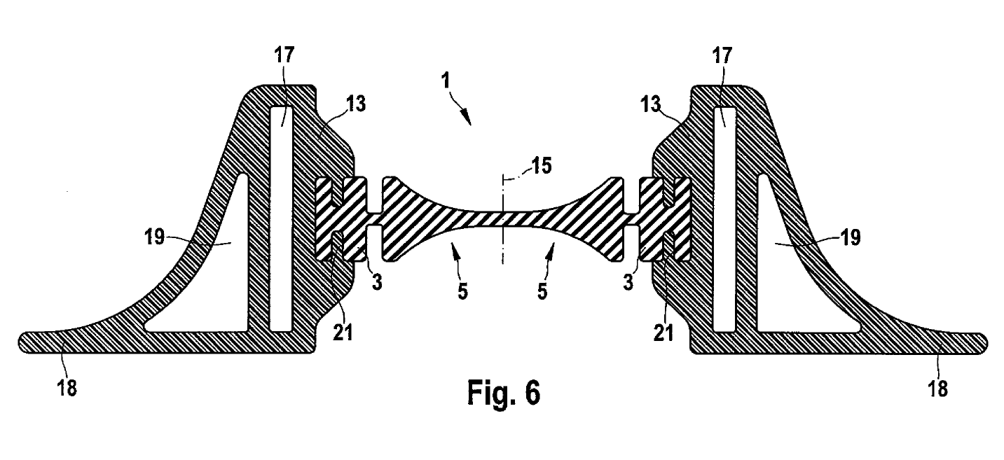

The embodiment shown in FIG. 6 differs from the embodiment shown in FIG. 5 in that the second profile 13 again has spoiler lips 18. As indicated above, the spoiler lips 18 on a second profile 13 are made of a thermoplastic, preferably a soft material, for example a soft thermoplastic or a thermoplastic elastomer.

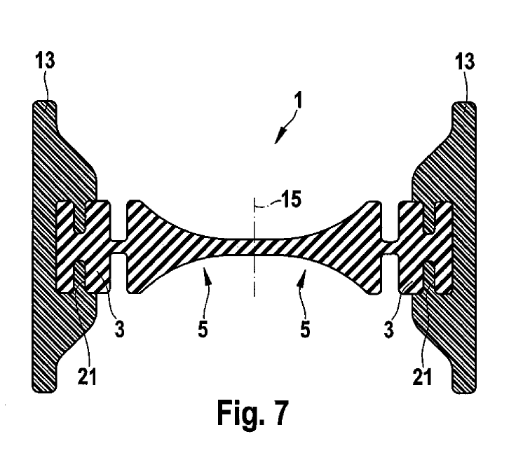

FIG. 7 shows a cross-sectional view of two wiping rubbers which are joined to one another at the lip section, have an undercut and are joined to a support profile which does not have a hollow space.

The wiping rubber shown in FIG. 7 corresponds essentially to that shown in FIG. 5. However, the second profile 13 does not have a hollow space. The wiping rubber is used without use of an additional spring rail. To achieve the necessary spring force required for operation of the wiping rubber, the second profile 13 is made of a high-temperature-resistant thermoplastic. When the extruded profile as shown here is a double profile made up of two wiping rubbers joined to one another at the lip section 5, the extruded profile is cut into individual profiles after the second profile 13 has been extruded on. The individual profiles are then preferably bent. A suitable radius to which the extruded profile is bent is, for example, in the range from 3000 to 5000 mm. After bending, the wiping edge formed on the axis of symmetry 15 is located on the outer radius.

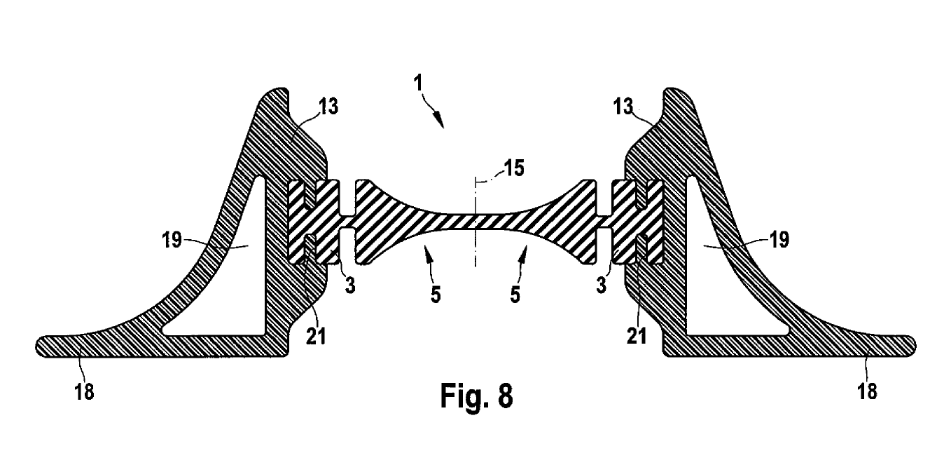

The embodiment shown in FIG. 8 corresponds essentially to the embodiment shown in FIG. 6 but differs from the latter in that the second profile 13 does not contain a hollow space 17 for accommodating a spring rail. As in the case of the embodiment shown in FIG. 7, the second profile 13 is in this case preferably made of a high-temperature-resistant thermoplastic. The use of the high-temperature-resistant thermoplastic enables the spring rail to be dispensed with. The extruded profile shown in FIG. 8 is also cut at the axis of symmetry 15 after the second profile 13 has been extruded on and is subsequently bent in order to produce the spring force required for the wiping operation. After cutting and bending, the profiles produced in this way are cut to the required length and cooled.

Apart from the embodiments shown here, in which the first profile 1 is a wiping lip for a wiping rubber of a windscreen wiper and the second profile 13 is a support profile, the process of the invention can also be used to produce any other profile in which a first profile composed of an elastomer material is joined to a second profile composed of a thermoplastic material.

1. A process for producing extrudates comprising a first profile (1) composed of an elastomer material and a second profile (13) joined to the first profile (1), which comprises the following steps:
a) extrusion of the first profile (1) composed of the elastomer material,
b) vulcanization of the first profile (1) composed of the elastomer material and
c) extrusion of a second profile (13) composed of a thermoplastic material onto the first profile (1) composed of the elastomer material.

2. The process as claimed in claim 1, characterized in that the second profile (13) composed of the thermoplastic material is extruded onto the first profile (1) composed of the elastomer material in step (c) before the first profile has cooled completely.

3. The process as claimed in claim 1, characterized in that the first profile (1) composed of the elastomer material is a wiping rubber and the second profile (13) composed of the thermoplastic material is a support profile joined to the wiping rubber.

4. The process as claimed in claim 1, characterized in that the elastomer material is selected from the group consisting of natural rubber, chloroprene rubber, butadiene rubber, styrene-butadiene rubber, ethylene-propylene copolymers, ethylene-propylene-diene terpolymers, ethylene-vinyl acetate copolymers, acrylonitrile-butadiene rubber, hydrogenated acrylonitrile-butadiene rubber, polyurethane elastomers and mixtures of these materials.

5. The process as claimed in claim 1, characterized in that the elastomer material is ethylene-propylene-diene terpolymer, natural rubber, chloroprene rubber or a mixture thereof.

6. The process as claimed in claim 1, characterized in that the thermoplastic material of which the second profile (13) is made is a thermoplastic or a thermoplastic elastomer.

7. The process as claimed in claim 6, characterized in that the thermoplastic is selected from the group consisting of polyolefin, polyamide and polyacrylates.

8. The process as claimed in claim 6, characterized in that the thermoplastic elastomer is selected from the group consisting of thermoplastic vulcanizates, thermoplastic polyurethane and thermoplastic polyolefin.

9. The process as claimed in claim 6, characterized in that the thermoplastic is a high-temperature-resistant thermoplastic.

10. The process as claimed in claim 1, characterized in that the extruded profile is bent to a radius in the range from 3000 to 5000 mm after the second profile (13) has been extruded on and, if appropriate, the extruded profile has been cut into at least two individual profiles.

11. An extruded profile comprising a first profile (1) and a second profile (13) joined to the first profile (1), where the first profile (1) is made of an elastomer material, characterized in that the second profile (13) contains a thermoplastic material.

12. The extruded profile as claimed in claim 11, characterized in that the thermoplastic material is a thermoplastic or a thermoplastic elastomer.

13. The extruded profile as claimed in claim 11, characterized in that the first profile (1) is a wiping rubber and the second profile (13) is a support profile joined to the wiping rubber.

14. The extruded profile as claimed in claim 13, characterized in that the support profile has a spoiler lip (18).

15. The extruded profile as claimed in claim 11, characterized in that the support profile is a hollow profile.

16. The extruded profile as claimed in claim 11, characterized in that the first profile (1) has at least one undercut (21) via which the first profile (1) is joined to the second profile (13).

17. (canceled)

18. (canceled)

19. A method of manufacturing a wiping rubber, the method comprising:
producing an extruded profile comprising a first profile (1) and a second profile (13) joined to the first profile (1), where the first profile (1) is made of an elastomer material, and the second profile (13) contains a thermoplastic material; and
using the extruded profile to produce a wiping rubber without metallic inserts.

20. The method of claim 19 comprising using the extruded profile to produce a wiping rubber for a windscreen wiper.

21. The method of claim 19 wherein the thermoplastic material present in the second profile is a high-temperature-resistant thermoplastic.

22. The method of claim 21 wherein the thermoplastic material present in the second profile is an aromatic polyamide, a liquid crystal polymer (LCP) or a polyphenylene sulfide (PPS).

23. The process as claimed in claim 9, characterized in that the thermoplastic is an aromatic polyamide, liquid crystal polymer (LCP) or polyphenylene sulfide.
